(19) United States
(12) Patent Application Publication
(10) Pub. No.: US 2026/0316499 A1
(43) Pub. Date: Oct. 15, 2026

(54) BUMPER ASSEMBLY WITH TOWING EYE

(71) Applicant: BENTELER AUTOMOBILTECHNIK GMBH, Paderborn (DE)

(72) Inventor: Britta PETERS, Paderborn (DE)

(21) Appl. No.: 19/643,801

(22) Filed: Apr. 10, 2026

(30) Foreign Application Priority Data
Apr. 11, 2025 (EP) 25170098.5

(51) Int. Cl. B60D 1/56; B60R 19/03; B60R 19/18; B60R 19/34

(52) U.S. Cl. CPC B60D 1/565; B60R 19/03; B60R 19/18; B60R 19/34

(57) ABSTRACT

The present disclosure relates to a bumper assembly for a motor vehicle, including a cross member which is coupled to the motor vehicle via crash boxes. The cross member is designed in cross-section as a closed hollow profile, and a sleeve for receiving a towing eye is arranged extending through the cross member. A front side of the cross member and optionally a back side of the cross member is/are embossed in the region of the sleeve, such that a front receiving plane is formed in the front side and optionally a back receiving plane is formed in the back side. The planes are parallel and offset to each other and extend in a plane oriented parallel to the motor vehicle vertical direction and motor vehicle transverse direction.

### RELATED APPLICATIONS

The present application claims priority of European Application Number 25170098.5 filed Apr. 11, 2025, the disclosure of which is hereby incorporated by reference herein in its entirety.

### FIELD

The Present Disclosure Relates to a Bumper Assembly.

### BACKGROUND

Motor vehicles have bumper assemblies. The motor vehicles can be electric vehicles or vehicles equipped with an internal combustion engine. A hybrid vehicle can also be used.

The bumper assembly includes a cross member. The cross member extends across the width of the vehicle. The cross member exhibits a curvature around the motor vehicle vertical direction. In most cases, such a bumper is coupled to the motor vehicle to the longitudinal members of the motor vehicle, via crash boxes.

In the event of a vehicle breakdown, but also, for example, during overseas transport, a towing eye is installed in a motor vehicle. Such a towing eye must be attached to the motor vehicle, as it is stored when not in use, for example in the trunk of the motor vehicle.

A sleeve-shaped receptacle is provided with a plug-in closure or an internal thread. The towing eye is then inserted or screwed into the sleeve using a web-shaped or bolt-shaped extension. Following this, a corresponding force can then be transmitted. For example, the motor vehicle can be towed by transferring a pulling force via the towing eye. The vehicle can also be lashed to a floor by using a suitable lashing device, such as a lashing strap, which is lashed diagonally downwards from the towing eye.

Corresponding sleeves are able to be attached to a bumper cross member.

### SUMMARY

The object of the present disclosure is to show a way to attach such a sleeve to a bumper assembly in a precise, mass-production-ready and structurally cost-effective manner with improved force transmission.

The aforementioned object is achieved according to the present disclosure.

The bumper assembly is suitable for a motor vehicle. It has a cross member which is coupled to the vehicle via crash boxes.

The cross member itself has a curved or arc-shaped profile. The curvature is curved around the motor vehicle vertical direction Z. The curvature has a changing radius of curvature. In at least one embodiment of the present disclosure, the cross member is less curved in a middle region and more curved in the end regions.

Crash boxes are attached to the cross member itself. The cross member is made of a steel material. The cross member or a profile, in at least one embodiment of the present disclosure, is a hat profile of the cross member, which can for example be made of a hot-formed and press-hardened carbon steel. In at least one embodiment of the present disclosure, it has a tensile strength Rm greater than 1350 MPa.

The cross member itself has a closed hollow profile in its cross-section. In at least one embodiment of the present disclosure, this hollow profile is formed by a hat profile. The opening of the hat profile points towards the front with respect to the motor vehicle longitudinal direction. The hat profile is then coupled with a closing plate. The closing plate extends in the transverse direction of the vehicle over a large part of the width or length of the cross member. In at least one embodiment of the present disclosure, the closing plate extends over the entire width or length of the cross member. The closing plate itself can be made of a steel having a tensile strength Rm greater than 500 MPa and less than 1200 MPa, between 500 MPa and 800 MPa. This would have the advantage that the closing plate itself is ductile. The cross member thus has a high inherent stiffness due to the hat profile, but a corresponding extensibility due to the closing plate, so that the cross member would not buckle or break during the pole test.

A sleeve for receiving a towing eye is now fitted through the cross member. The sleeve itself is made of a steel material. For example, an internal thread can be formed in the sleeve so that a towing eye with its web-shaped or bolt-shaped extension is screwed into the sleeve.

According to the present disclosure, a front side of the cross member and optionally a back side of the cross member are embossed in the region of the sleeve. In the context of this present disclosure, “embossed” means that a region is formed in a targeted way. In at least one embodiment of the present disclosure, as a bending forming or embossing forming process, which is called embossing. The embossing can take place during the actual forming process of the cross member. However, the embossing can also take place after the actual forming process of the cross member, so that the region or the receiving region is embossed again. The region is a receiving region. A respective opening, for example, a hole, is formed in region of both the front and back sides of the cross member. This opening or hole can, for example, be a circular cutout. The sleeve is then inserted by passing through the respective hole or cutout, thus passing through both the front and back sides.

The region in the front wall and optionally also the region in the back wall are then designed as the receiving plane. This means that this receiving plane is inherently flat. There is no curvature or anything similar formed here. The flat plane is also designed such that, when the sleeve is inserted, a distance of at least 3 mm, up to 20 mm, and between 4 mm and 10 mm is formed around the outer lateral surface. Thus, the outer lateral surface of the sleeve can be welded to the receiving plane all the way around. In top or front view, the receiving plane itself can be circular. However, the receiving plane can also be angular or rectangular in front view. However, at least a distance of 4 mm to 10 mm is formed everywhere by using the aforementioned millimeter specifications.

In order for the sleeve to optimally transmit a tensile force in the motor vehicle longitudinal direction, the sleeve is provided with a stepped shoulder at one end on the vehicle side. The stepped shoulder refers to the radial direction of the sleeve towards the outside. Therefore, the sleeve has a thickening or bulge at the vehicle-side end. This thickening, bulge, or stepped shoulder then lies against the back of the cross member. This optimizes the transmission of force in the motor vehicle longitudinal direction, when subjected to tensile force via the towing eye.

To improve the mounting and alignment of the sleeve for receiving the towing eye, the back and front of the cross member are embossed in the receiving region of the sleeve, as already mentioned. This results in a front receiving plane and, optionally, a back receiving plane on the back of the cross member. The two receiving planes of the front and back are arranged in a way that is parallel to each other and offset. In at least one embodiment of the present disclosure, both planes are parallel and offset or run oriented to a plane that is parallel to the plane spanned by the vehicle vertical and transverse directions. The receiving plane can also be positioned at the front or back at an angle of up to ±5° to the plane spanned by the vehicle vertical and transverse directions.

This offers two advantages. Firstly, the orientation or geometric precision when inserting the sleeve, i.e. during the initial mounting of the bumper assembly, for example as a welded assembly component or similar, is improved.

When using the towing eye, i.e., when transmitting force, it has been found according to the present disclosure that improved force transmission takes place with a corresponding receiving plane on the front and the back. In at least one embodiment of the present disclosure, the sleeve is welded at least in sections, and completely around the sleeve, with the front, i.e., the closing plate, but also with the back of the cross member. The welding can be carried out in terms of the design of the weld seam, but also in terms of the quality of the weld seam to be achieved, by the parallel planes. Likewise, a right angle results between the outer lateral surface of the sleeve and the respective receiving plane. This in turn improves the weld quality as well as the forces that can be transmitted through the weld.

In at least one embodiment of the present disclosure, on the front receiving plane, with reference to the transverse direction of the vehicle, a region of the front of the cross member is bent backwards. A region that lies on the outside in the transverse direction of the vehicle is bent forward in the longitudinal direction. This results in the front plane or receiving plane in the region of the front or front wall of the cross member. This receiving plane is, at least partially, set back relative to the front wall in the motor vehicle longitudinal direction. This in turn offers the advantage that one end of the sleeve, i.e., one end face of the sleeve, protrudes in the motor vehicle longitudinal direction relative to this receiving plane. The end face is spaced away from a weld between the outer lateral surface of the sleeve and the front wall or front of the cross member. However, because the receiving plane is at least partially set back in the longitudinal direction relative to the front wall, the resulting absolute protrusion of the end wall of the sleeve is reduced. In at least one embodiment of the present disclosure, the sleeve does not protrude as much compared to a curved, but continuous, front wall. The sleeve is therefore set back relative to the longitudinal direction without any restrictions regarding the usability of the sleeve. In at least one embodiment of the present disclosure, The end wall is spaced away from the weld seam between the sleeve and the front wall, for example, spaced away in such a way that it protrudes in the motor vehicle longitudinal direction. The end wall of the sleeve protrudes between 6 mm and 20 mm, between 7 mm and 15 mm and between 8 mm and 10 mm from the receiving plane.

The region, for example, the receiving region in the front receiving plane and/or the region, for example, the receiving region in the back receiving plane, is round in a respective top view. In this case, a top view means a front view of the bumper cross member from the front or back in the motor vehicle longitudinal direction and would make the region for receiving the sleeve appear round.

For the embossing of the respective region, in the case of a curved cross member profile, this means that an inner part of the region of the front, relating to the transverse direction of the motor vehicle, is embossed in the direction of the cross member. An outer part of the region at the front, relative to the transverse direction of the vehicle, is embossed outwards relative to the motor vehicle longitudinal direction. On the back side, an inner part of the region, relative to the transverse direction of the motor vehicle, is embossed towards the back in the motor vehicle longitudinal direction, i.e., outwards from the cross member. An outer region on the back of the cross member, relating to the transverse direction of the motor vehicle, is then embossed inwards, i.e., into an interior space of the cross member.

The region for receiving the sleeve is larger than just the opening or hole for the sleeve to pass through. This is due to the fact that welding takes place. For this purpose, the region from an inside of the opening or hole to the sleeve is formed to be at least 1.5 times the wall thickness, or 2.5 times to 8 times the wall thickness all round. This means that the diameter of the region is composed of the diameter or outer diameter of the sleeve plus 3 to 16 times, or 4 to 10 times, the wall thickness of the front wall or the back wall.

To make it easy to insert the sleeve initially, a clearance fit is designed between the opening on the back and/or front and the sleeve. The bulge or stepped shoulder then engages behind the back wall when the sleeve is fully inserted.

### BRIEF DESCRIPTION OF THE DRAWINGS

Further advantages, features, properties, and aspects of the present disclosure are the subject of the following description. Embodiment variants are shown in the schematic figures. The individual features previously and successively described can be combined with each other as desired without departing from the scope of the present disclosure. In particular:

FIG. 1 shows a perspective view of bumper assembly according to at least one embodiment of the present disclosure,

FIG. 2 shows a front view of the cross member or the front of the cross member according to at least one embodiment of the present disclosure,

FIG. 3 shows a longitudinal sectional view along the section line III-III of FIG. 2 according to at least one embodiment of the present disclosure,

FIG. 4 shows the sleeve again in a longitudinal section view according to at least one embodiment of the present disclosure,

FIG. 5 shows a longitudinal section view through a crash box according to at least one embodiment of the present disclosure, and

FIG. 6 shows a longitudinal section view, schematically simplified with cross member and inserted sleeve according to at least one embodiment of the present disclosure.

### DETAILED DESCRIPTION

In the figures, the same reference numerals are used for identical or similar components, even if a repeated description or representation is omitted.

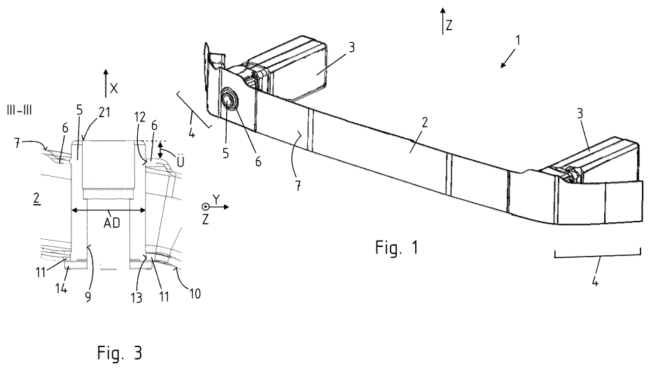

FIG. 1 shows a perspective view of a bumper assembly 1. This assembly has a cross member 2. The cross member 2 is respectively coupled to crash boxes 3. The end regions 4 of the cross member 2 have a stronger curvature around the motor vehicle vertical direction Z. In the region of the crash box 3 on the left side of the image plane, a sleeve 5 is arranged to receive a towing eye not shown in detail. The sleeve 5 is radially surrounded by an embossed region on the front of the cross member 2 or closing plate, which forms a front receiving region for the sleeve 5.

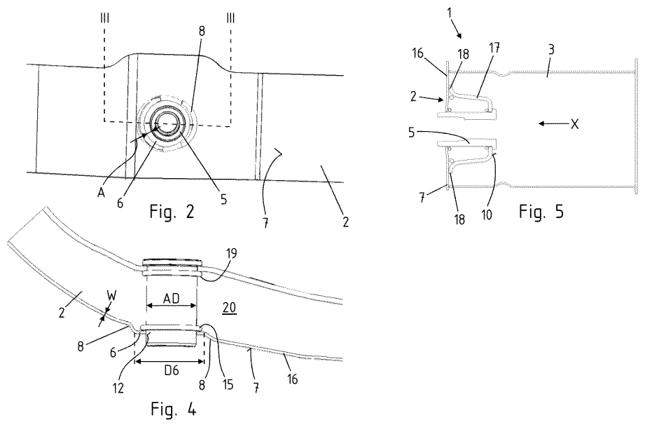

FIG. 2 shows an end view of the cross member 2 or the front side 7 of the cross member 2. The sleeve 5 is arranged here and a region 6 immediately surrounding the sleeve 5 is round in this end view or front view. This region 6 is embossed compared to the rest of the front side, meaning it has been formed differently in a forming process. This results in a radius region or transition radius 8 surrounding the region. This is not round in the front view, as it conforms to the curvature of the front side 7 or closing plate in order to provide a transition to the front side 7. FIG. 2 also shows a distance A. The distance A from an outer lateral surface of the sleeve 5 is at least 3 mm, at least 4 mm, and at most 10 mm. The distance A is formed all around. The distance A thus defines the region 6, which is flat or planar. Thus, a weld seam, not shown in detail, can be formed all around. The weld seam then lies against the outer lateral surface of the sleeve 5 and in the region 6 as a flat receiving plane. The quality of the welded joint is high due to the geometric design.

In at least one embodiment of the present disclosure, the region 6 of the receiving plane is arranged perpendicular to a central longitudinal axis of the sleeve 5.

FIG. 3 now shows a longitudinal sectional view according to section line III-III from FIG. 2. The sleeve 5 itself has an internal thread 9 which is not shown in detail. In contrast to a front side 7 and the back side 10 shown here, there is a region 6 embossed in the front side 7 and an region 11 embossed in the back side 10. The region 6 on the front side 7 and region 11 on the back side 10 can each also be called a receiving region. The region 6 of the front side 7 and region 11 of the back side 10 are offset parallel to each other. In at least one embodiment of the present disclosure, regions 6 and 11 are designed parallel to a plane spanned in the transverse direction Y and the vertical direction Z of the motor vehicle. This means that the remainder of the cross member 2, namely the front side 7 and the back side 10 of the cross member 2, curves around the vertical direction Z. The region 6 and the region 11 are planar and arranged parallel to each other, at least spaced apart, or at an angle of at most ±5° each, and are oriented parallel to each other or offset by at most ±5° each from a plane defined by the transverse direction Y and the vertical direction Z of the vehicle. A front end wall 21 of the sleeve 5 protrudes forward in the longitudinal direction X of the vehicle relative to the plane 6. Thus, a circumferential weld (not shown in detail) of plane 6 to the outer lateral surface of the sleeve 5 is spaced apart from the end wall 21 of the sleeve 5. At the same time, however, the absolute projection of the end wall 21 of the sleeve 5 relative to the front surface 7 of the cross member 2 is reduced in the comparative case where plane 6 is not stamped into the front surface 7 of the cross member 2.

Furthermore, a protrusion Ü is shown in FIG. 3. With this, the front side 21 of the sleeve 5 protrudes beyond the region 6. The region 6 can also be referred to as a plane or receiving plane.

The region 6 has an opening 12 and the region 11 has an opening 13. The sleeve 5 is inserted through these openings. The sleeve 5 has a constant outer diameter AD along its longitudinal profile. At one vehicle-side end of the sleeve 5, shown below in relation to the image plane, the sleeve 5 has a stepped shoulder 14. The stepped shoulder 14 can also be formed as a bulge. The stepped shoulder 14 protrudes in the radial direction of the sleeve 5 beyond the outer diameter. The stepped shoulder 14 thus engages the back side 10 of the cross member 2 in a form-fitting manner and allows for a certain tolerance during welding to the cross member 2. A tensile force in the longitudinal direction X of the vehicle, which is not shown in detail, is thus optimally transmitted.

Furthermore, the sleeve 5 is shown again in a longitudinal section view in FIG. 4. Here it is shown that opposite the front side 7 of the cross member 2, a corresponding closing plate 16 and an optional sealing ring 15 are formed. This can be formed on the inside of the front side 7. The front side 7 is formed here by a closing plate 16. This is also shown again in FIG. 5, which shows a longitudinal section view through a crash box 3. The cross member 2 itself is then formed by a corresponding hat profile 17. The opening of the hat profile 17 according to FIG. 5 points forward in the longitudinal direction X of the motor vehicle or away from the vehicle. The closing plate 16 is coupled to the hat profile 17, not shown in detail, via the flanges 18 of the hat profile 17 by a welding process. Furthermore, the sleeve 5 is also welded to the back side 10 of the cross member 2, here the hat profile 17.

Furthermore, according to FIG. 4, the front region 6 has a diameter D6, which is composed of the outer diameter of the sleeve 5 plus at least 3 times the wall thickness, up to 16 times the wall thickness of the component, here the closing plate 16. This means that radially around the opening of the closing plate 16, the region of the wall thickness is at least 1.5 times larger than the opening itself.

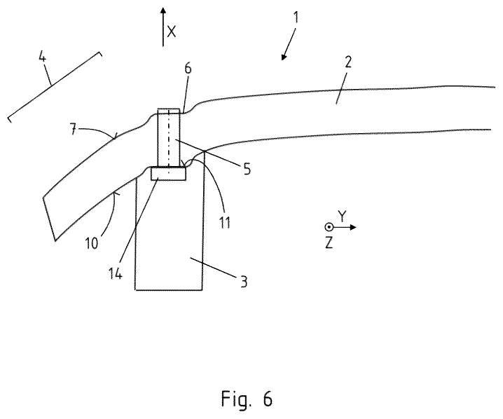

FIG. 6 shows a longitudinal section view, schematically simplified with cross member 2 and inserted sleeve 5. This is inserted in such a way that it rests against a back side 10 of the cross member 2 and completely penetrates both the back side 10 and the front side 7 of the cross member 2. Corresponding weld seams 16 can be used. The cross member 2 itself has a curvature around the motor vehicle vertical direction Z. The curvature around the motor vehicle vertical direction Z is more pronounced in the end regions of the cross member 2. The region 6 and the region 11 are offset parallel to each other or arranged at a maximum angle of ±5° each. However, the region 6 and the region 11 are also parallel offset or arranged at a maximum angle of ±5° through a plane formed by the transverse direction Y of the motor vehicle and the vertical direction Z of the motor vehicle.

1-10. (canceled)

11. A bumper assembly for a motor vehicle, comprising:
a cross member which is configured to be coupled to the motor vehicle via crash boxes,
wherein
the cross member, in cross-section, has as a closed hollow profile, and a sleeve configured to receive a towing eye,
the sleeve extends through the cross member,
a front side of the cross member is embossed in an embossed region surrounding the sleeve to form a front receiving plane in the front side, and
the front receiving plane extends parallel or at an angle of at most ±5° to a plane spanned by a vertical direction and a transverse direction of the motor vehicle.

12. The bumper assembly according to claim 11, wherein the cross member is curved around a vertical axis of the motor vehicle.

13. The bumper assembly according to claim 11, wherein the cross member comprises a hat profile with a closing plate.

14. The bumper assembly according to claim 11, wherein the embossed region of the front receiving plane is round in front view of the bumper assembly.

15. The bumper assembly according to claim 11, wherein the embossed region has a diameter comprising an outer diameter of the sleeve plus 3 times to 16 times a wall thickness of a front wall of the cross member.

16. The bumper assembly according to claim 11, wherein the sleeve has an outer diameter which is constant over a length of the sleeve and at least at an end of the sleeve which is welded to the embossed region of the front receiving plane.

17. The bumper assembly according to claim 16, wherein the sleeve has a stepped shoulder at a vehicle-side end which is larger than the outer diameter of the sleeve.

18. The bumper assembly according to claim 11, wherein the sleeve is welded radially around a front wall or a back wall of the cross member at least in sections.

19. The bumper assembly according to claim 11, wherein the cross member comprises a hot-formed and press-hardened steel.

20. The bumper assembly according to claim 11, wherein an opening of the front receiving plane has a clearance fit to the sleeve.

21. The bumper assembly according to claim 11, wherein the sleeve is welded radially around a front wall or a back wall of the cross member over at least ¾ of an outer circumference or outer diameter of the sleeve.

22. The bumper assembly according to claim 11, wherein the cross member comprises a hot-formed and press-hardened steel having a tensile strength Rm greater than 1350 MPa.

23. The bumper assembly according to claim 11, wherein
a back side of the cross member is embossed in a further embossed region surrounding the sleeve to form a back receiving plane in the back side, and
the back receiving plane extends parallel or at an angle of at most ±5° to the plane spanned by the vertical direction and the transverse direction of the motor vehicle.

24. The bumper assembly according to claim 23, wherein at least one of the embossed region of the front receiving plane or the further embossed region of the back receiving plane is round in front view of the bumper assembly.

25. The bumper assembly according to claim 23, wherein at least one of
the embossed region has a diameter comprising an outer diameter of the sleeve plus 3 times to 16 times a wall thickness of a front wall of the cross member, or
the further embossed region has a diameter comprising the outer diameter of the sleeve plus 3 times to 16 times a wall thickness of a back wall of the cross member.

26. The bumper assembly according to claim 23, wherein an opening of at least one of the front receiving plane or the back receiving plane has a clearance fit to the sleeve.
